(19) United States
(12) Patent Application Publication
(10) Pub. No.: US 2024/0199876 A1
(43) Pub. Date: Jun. 20, 2024

(54) EXTRUDABLE COMPOSITIONS COMPRISING POLYMERIC PARTICLES COATED BY CARBON NANOTUBES

(71) Applicant: NEMO NANOMATERIALS LTD., Petach Tikva (IL)

(72) Inventors: Ilana HAYMOV, Netanya (IL); Maayan MIZRAHI-DAGAN, Bene Atarot (IL); Yehonatan ANTEBI, Herzelia (IL); Smadar KORIN, Ein Habsor (IL); Dmitry LEKHTMAN, Afula (IL); Moran BEN BASAT, Tel Aviv (IL); Yair SINGER, Ramat Gan (IL); Liran GAMLIEL, Ramat Gan (IL); Tsafrir ELIYAHU, Givat Shmuel (IL)

(21) Appl. No.: 18/288,564

(22) PCT Filed: Apr. 28, 2022
(86) PCT No.: PCT/IL2022/050438

§ 371 Date: Oct. 26, 2023

Related U.S. Application Data
(60) Provisional application No. 63/180,724, filed on Apr. 28, 2021.

(51) Int. Cl. C08L 77/02; C08K 3/04; C08K 7/14; H01B 1/24

(52) U.S. Cl. CPC C08L 77/02; C08K 3/041; C08K 7/14; C08K 2201/001; C08K 2201/011; C08L 2203/30; C08L 2207/53; H01B 1/24

(57) ABSTRACT

A composition comprising a plurality of microsized core-shell particles is provided, wherein the shell comprises CNT and further comprises a surfactant, and wherein the core comprises a polymer. Further, articles derived from the compositions of the invention are provided.

### CROSS REFERENCE

This application claims the benefit of priority of U.S. Provisional Patent Application No. 63/180,724, filed on Apr. 28, 2021, the content of which is incorporated herein by reference in its entirety.

### FIELD OF THE INVENTION

The present invention is in the field of polymeric particles comprising a carbon nano-tubes based shell and uses thereof.

### BACKGROUND OF THE INVENTION

Various composite materials comprising electrically conductive additives (such as carbon nano-tubes, carbon fiber and metallic particles) dispersed within polymeric insulating matrices and characterized by an enhanced electrical conductivity have been the subject of both theoretical and experimental studies over the last decades, due to their wide diversity of applications in electrical and electronic industries. Typically, such composite materials are prepared by melt-mixing of conductive additives with the polymer in a molten state. In order to obtain materials with high conductivity, high loading of the conductive additives is required. However, currently available preparation processes are not compatible with current industrial mass-production process of the composite materials, which is primarily based on extrusion.

Thus, there is an unmet need to develop novel compositions suitable for shaping by extrusion, and thus being applicable in the industrial-scale production of conductive polymeric composite materials.

### SUMMARY OF THE INVENTION

According to one aspect, there is provided a composition comprising a particle comprising a polymeric core in contact with a shell comprising CNT, wherein: the polymeric core comprises a thermoplastic polymer; a weight portion of the CNT within the particle is between 1 and 5%; a size of the particle is between 1 and 2000 μm.

In one embodiment, the CNT is a single-wall CNT.

In one embodiment, the polymer has a volume resistivity of at least 10¹³ ohm*cm.

In another aspect, there is a composition comprising a plurality of particles of the invention.

In one embodiment, the composition further comprising a fiber (e.g. a glass fiber).

In one embodiment, the composition is characterized by a Melt Flow Index (MFI) between 0.1 and 100.

In one embodiment, the composition is extrudable.

In another aspect, there is an article comprising the composition of the invention.

In one embodiment, the article is manufactured by a method comprising any of: extrusion, injection, hot blown film, and molding or any combination thereof.

In one embodiment, the article is characterized by volume resistivity of between 10¹² and 1 ohm*cm.

In one embodiment, each of (i) CNT and (ii) surfactant is present within the article at a w/w concentration of between 0.01% and 5%; and wherein the article is characterized by volume resistivity of between 10¹⁰ and 10² ohm*cm.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

The invention will now be described in relation to certain examples and embodiments with reference to the following illustrative figures so that it may be more fully understood. In the drawings:

FIG. 1A is a graph presenting EMI attenuation of an exemplary article of the invention composed of polyamide 6 with about 1% w/w of CNT (**), versus an article having substantially the same chemical composition and characterized by substantially non-homogenous distribution of CNTs (*).

FIGS. 1B-1C represent images of an exemplary plaque of the invention of (1B) and of a control plaque (1C). As presented in FIG. 1C, the CNT aggregates are visually detectable on the article's surface (white arrows), indicating a non-homogenous distribution of CNTs.

FIG. 2 is a schematic illustration of the EMI attenuation measurement, as described herein.

### DETAILED DESCRIPTION OF THE INVENTION

The present invention, in some embodiments thereof, relates to a particle comprising a polymeric core in contact with a shell comprising CNT, wherein: the polymeric core comprises a thermoplastic polymer; a weight a portion of the CNT within the particle is between 1 and 10%; and a size of the particle is between 30 and 2000 μm. Additionally, the present invention, in some embodiments thereof, relates to a composition comprising a plurality of particles of the invention, wherein the composition is extrudable. The present invention, in some embodiments thereof, is based on a surprising finding that the core-shell particles of the invention comprising a polymeric core with a particle size as described herein, are characterized by an improved physical stability (e.g. having the shell stably attached to the polymeric core upon exposing thereof to a polar organic solvent, such as IPA) as compared to analogous particles comprising a polymeric core with a particle size greater than 2 mm.

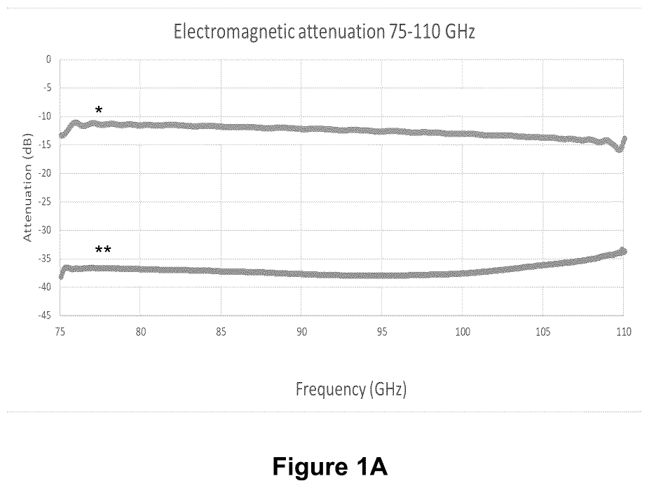

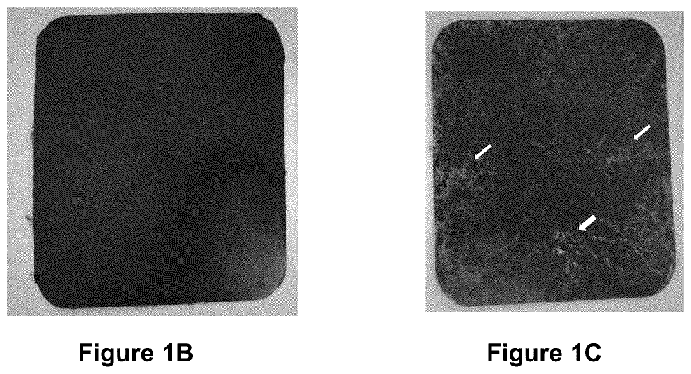

The present invention, in some embodiments thereof, relates to an article or a coating formed by extrusion of the composition of the invention, and wherein the article or the coating is characterized by electrical conductivity. The present invention, in some embodiments thereof, is based on a surprising finding that the particles of the invention are compatible with the conditions suitable for thermal processing of a thermoplastic polymer (such as extrusion, thermal molding, etc.), further resulting in composite materials and/or shaped articles characterized by homogeneous distribution of the CNT within the polymeric matrix (see FIGS. 1B-1C).

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

### Particle

According to one aspect, there is provided a particle, comprising a polymeric core in contact with a shell comprising CNT, wherein: the polymeric core comprises a thermoplastic polymer; and wherein a size of the particle is between 30 and 2000 μm. In some embodiments, the plurality of particles of the invention are extrudable particles, capable of forming an article via an extrusion process.

Accordingly, the invention, in some embodiments thereof, is directed to a composition comprising a plurality of core-shell particles, wherein each of the particles comprises a meltable or extrudable core comprising a thermoplastic polymer and a shell comprising CNT, wherein upon extrusion of the composition an article is formed incorporating a predefined weight ratio of the CNT within a polymeric matrix, wherein the polymeric matrix comprises the thermoplastic polymer. Thus, the composition of the invention can be utilized so as to form a homogenous dispersion comprising the molten thermoplastic polymer and the CNTs dispersed therewithin. Specifically, the composition of the invention can be utilized for the manufacturing of large-scale dispersions suitable for industrial applications. In some embodiments, the article of the invention is characterized by a uniform distribution of the CNTs, and is further characterized by modified physical properties compared to the physical properties of the pristine polymer, such as electrical conductivity.

In some embodiments, the particle of the invention is a solid, or is in a solid state. In some embodiments, the particle of the invention comprises a solid polymeric core coated by a shell. In some embodiments, the polymeric core of the particle is bound to the shell. In some embodiments, the polymeric core of the particle is stably bound to the shell. In some embodiments, the shell of the particle is stably bound to the polymeric core.

In some embodiments, the polymeric core of the particle is encapsulated by the shell. In some embodiments, at least a portion of the polymeric core of the particle is encapsulated by or stably bound to the shell. In some embodiments, the polymeric core of the particle is completely encapsulated by or stably bound to the shell. In some embodiments, the polymeric core of the particle is surrounded by the shell. In some embodiments, the particle is substantially devoid of a void space at the interphase between the core and the shell.

In some embodiments, the particle of the invention is in a form of a core-shell particle (e.g. solid core-shell particle), comprising the polymeric core (e.g. solid polymeric core) and the shell encapsulating the core, wherein the core and the shell are stably bound to each other (e.g. form a stable particle, substantially devoid of disintegration) via a non-covalent bond, and wherein the shell comprises SWCNT. In some embodiments, the polymeric core is substantially devoid of electrical conductivity. In some embodiments, the polymeric core of the particle of the invention comprises a non-conductive thermoplastic polymer.

In some embodiments, the particle of the invention comprises or consist of a polymeric core and a shell, wherein the polymeric core and the shell have different melting temperatures. In some embodiments, the particle of the invention comprises or consist of a polymeric core and a shell, wherein the polymeric core has a lower or greater melting temperature than the shell. In some embodiments, the core has a melting temperature of at most 650° C., at most 600° C., at most 500° C., at most 300° C., at most 200° ° C., including any range between.

In some embodiments, the particle of the invention comprises the shell (or coating) bound to an outer surface of the core. In some embodiments, the shell is stably attached to the outer surface of the core.

In some embodiments, the terms “polymeric core”, “solid polymeric core”, and “core” are used herein interchangeably.

In some embodiments, the core and/or the particle of the invention is characterized by a spherical shape. In some embodiments, the core and/or the particle of the invention is characterized by an irregular shape. The particle(s) and/or the polymeric core can be generally shaped as a sphere, incomplete-sphere, a rod, a cylinder, a ribbon, a sponge, and any other shape, or can be in a form of a cluster of any of these shapes, or can comprise a mixture of one or more shapes.

In some embodiments, at least 80%, at least 90%, at least 95%, at least 99%, at least 99.9%, of the polymeric core of the particle is enclosed within or bound to the shell.

In some embodiments, the shell is in a form of a homogenous layer. In some embodiments, the chemical composition of the shell is substantially homogenous thorough any one shell's dimension. In some embodiments, the shell is in a form of a layer enclosing or bound to the core. In some embodiments, the shell is in a form of a distinct layer on top of the core. In some embodiments, the shell and the core of the particle disclosed herein, are characterized by different chemical compositions, and/or by different dimensions (or cross-sections). In some embodiments, the thickness of the shell within the composition of the invention (e.g. a composition comprising a plurality of particles) may substantially vary. In some embodiments, the thickness of the shell is predetermined inter alia by the size of the core.

By “uniform” or “homogenous” it is meant to refer to size (or thickness) distribution that varies within a range of less than e.g., +500%, +50%, +40%, +30%, +20%, or +10%, including any value therebetween.

In some embodiments, the term “layer”, refers to a substantially uniform-thickness of a substantially homogeneous substance. In some embodiments, the shell is or comprises a single layer, or a plurality of layers. In some embodiments, the particle of the invention comprises a single layer shell. In some embodiments, a composition of the invention is substantially devoid of particles disclosed herein comprising a multi-layered shell.

In some embodiments, the CNT is or comprises a carbon nano-structure (e.g., a single carbon nano-structure specie or a plurality of distinct carbon nano-structure species. The term “carbon nano-structure” is well known to a skilled artisan and refers inter alia to 2D carbon material, such as carbon fiber, carbon nanotube (single wall or multi wall, linear or branched), carbon black, graphene, and fullerene, or any combination thereof.

In some embodiments, the CNT is or comprises a single-wall carbon nano-tube (SWCNT). In some embodiments, the CNT is electrically conductive CNTs (e.g., electrically conductive SWCNT). In some embodiments, the CNT optionally comprises a multi-wall carbon nano-tube (MWCNT). In some embodiments, the CNT comprises SWCNT and optionally comprises an additional carbon nano-structure.

In some embodiments, the CNT is characterized by an aspect ratio between 130 and 10,000, between 130 and 200, between 130 and 1,000, between 1000 and 5,000, between 5000 and 10,000, between 130 and 7,000, between 7000 and 10,000, including any range between.

In some embodiments, the term “bound” refers to any non-covalent bond or interaction, such as electrostatic bond, dipol-dipol interaction, van-der-walls interaction, ionotropic interaction, hydrogen bond, hydrophobic interactions, pi-pi stacking, London forces, etc. In some embodiments, the non-covalent bond or interaction is a stable bond or interaction, wherein stable is as described herein.

In some embodiments, a weight a portion of the shell within the particle is between 0.1 and 10%; between 0.1 and 1%; between 1 and 2%; between 5 and 10%; between 1 and 3%; between 3 and 5%; between 5 and 7%; between 7 and 10%; including any range or value therebetween.

In some embodiments, a thickness of the shell is between 0.001 and 100 um, between 0.001 and 0.01 μm, between 0.01 and 0.1 μm, between 0.1 and 1 um, between 1 and 10 um, between 1 and 5 um, between 5 and 10 um, between 10 and 20 um, between 20 and 40 um, between 40 and 50 um, between 50 and 60 um, between 60 and 80 um, between 80 and 100 um, including any range or value therebetween.

In some embodiments, the shell comprises carbon nano-tubes (CNT). In some embodiments, the shell comprises single-wall carbon nano-tubes (SWCNT). In some embodiments, the particle of the invention comprises a polymeric core in contact with or bound to the shell, wherein the shell comprises SWCNT. In some embodiments, the CNT (e.g. SWCNT) is uniformly distributed on top of the core of the particle of the invention.

In some embodiments, a weight a portion of the SWCNT within the particle of the invention is between 0.1 and 10%, between 0.1 and 1%, between 1 and 5%; between 5 and 10%; between 1 and 3%; between 3 and 5%; between 5 and 7%; between 0.1 and 5%; between 7 and 10%; including any range or value therebetween.

In some embodiments, a weight a portion of the SWCNT within the particle (or within the composition) of the invention is between 0.00001% and 5%, between 0.00001% and 0.1%, between 0.00005% and 5%, between 0.00001% and 0.00005%, between 0.00001% and 0.0001%, between 0.00001% and 0.001%, between 0.0001% and 5%, between 0.0001% and 2%, between 0.001% and 5%, between 0.001% and 2%, between 0.001% and 1%, between 0.001% and 0.005%, between 0.005% and 0.01%, between 0.01% and 5%, between 0.01% and 2%, between 0.01% and 1%, between 0.01% and 0.5%, between 0.01% and 0.05%, between 0.05% and 0.1%, between 0.1% and 0.5%, between 0.1% and 5%, between 0.5% and 1%, between 1% and 2%, between 2% and 3%, between 3% and 5%, between 5% and 10%, including any range therebetween.

A skilled artisan will appreciate, that the exact weight a portion of the SWCNT within the particle of the invention is predetermined by the desired SWCNT content of the article formed by extrusion of the composition of the invention. Thus, the final SWCNT content of the article (predetermined by any desired physical property of the article) predetermines the weight a portion of the SWCNT within the particle of the invention. Additionally, the final SWCNT content of the article (predetermined by any desired physical property of the article) can be predetermined by the weight a portion of the SWCNT within the particle of the invention.

In some embodiments, the shell, as described herein, comprises SWCNT and optionally the surfactant of the invention and further comprises a carbon nano-particle. Non-limiting examples of carbon nano-particles include but are not limited to: MWCNT, carbon black, fullerene, nano graphene, nano graphite, nano-diamond, carbon nano-rod, carbon fiber, graphene fiber, including nay combination thereof. In some embodiments, the carbon nano-particle comprises a plurality of particles, wherein the particles are same. In some embodiments, the carbon nano-particle comprises a plurality of different carbon nanoparticles.

In some embodiments, a weight a portion of the CNT within the particle of the invention is between 0.1 and 10%, between 0.1 and 1%, between 1 and 5%; between 5 and 10%; between 1 and 3%; between 3 and 5%; between 0.00001% and 5%, between 0.00001% and 10%, between 0.00001% and 0.1%, between 0.00005% and 5%, between 0.00001% and 0.00005%, between 0.00001% and 0.0001%, between 0.00001% and 0.001%, between 0.0001% and 5%, between 0.0001% and 2%, between 0.001% and 5%, between 0.001% and 2%, between 0.001% and 1%, between 0.001% and 0.005%, between 0.005% and 0.01%, between 0.01% and 5%, between 0.01% and 2%, between 0.01% and 1%, between 0.01% and 0.5%, between 0.01% and 0.05%, between 0.05% and 0.1%, between 0.1% and 0.5%, between 0.1% and 5%, between 0.5% and 1%, between 5 and 7%; between 7 and 10%; including any range or value therebetween.

In some embodiments, a weight a portion of the CNT within the shell of the particle of the invention is between 5 and 99%, between 5 and 10%, between 10 and 60%, between 60 and 70%, between 70 and 80%, between 80 and 85%, between 85 and 90%, between 90 and 95%, between 95 and 97%, between 97 and 99%, including any range or value therebetween.

In some embodiments, the SWCNT content of the shell and/or of the particle described herein, is at least 60%, at least 65%, at least 70%, at least 75%, at least 80%, at least 85%, at least 90% including any range between, by weight relative to the total CNT content of the particle.

In some embodiments, the multi-wall CNT (MWCNT) content of the shell and/or of the particle described herein, is at most 30%, at most 25%, at most 20%, at most 15%, at most 10%, at most 5%, at most 1% including any range between, by weight relative to the total CNT content of the particle.

In some embodiments, a weight portion of the CNT within the particle of the invention comprising SWCNT and optionally an additional carbon nano-particle (such as MWCNT, carbon black, fullerene, graphene, etc.) is referred to herein, as the CNT content of the particle.

In some embodiments, the shell is substantially devoid of a polymer. In some embodiments, the shell is substantially devoid of an additional carbon nano-particle. In some embodiments, the shell is substantially devoid of a fiber (e.g. glass fiber, carbon fiber etc.).

In some embodiments, the shell further comprises a surfactant. In some embodiments, the surfactant facilitates binding of the CNT (e.g. SWCNT) to the polymeric core of the particle.

In some embodiments, at least 80%, at least 85%, at least 90%, at least 93%, at least 95%, at least 97%, at least 99%, at least 99.9%, including any range between, by weight of the shell of the particle of the invention is composed of the CNT (e.g. SWCNT) and the surfactant.

In some embodiments, a w/w ratio of the surfactant to the CNT (e.g. SWCNT) within the shell or within the particle of the invention is between 20:1 and 10:1, between 10:1 and 0.1:1, between 10:1 and 0.5:1, between 10:1 and 8:1, between 8:1 and 5:1, between 5:1 and 3:1, between 3:1 and 2:1, between 9:1 and 7:1, between 7:1 and 5:1, including any range between.

In some embodiments, a w/w concentration of the surfactant within the particle of the invention is less than 0.1%, less than 0.01%.

In some embodiments, a w/w concentration of the surfactant within the particle of the invention is between 0.001% and 30%, between 0.001% and 0.1%, between 0.1% and 1%, between 1% and 10%, between 10% and 30%, between 0.00001% and 5%, between 0.00001% and 5%, between 0.00005% and 5%, between 0.00001% and 0.00005%, between 0.00001% and 0.0001%, between 0.00001% and 0.001%, between 0.0001% and 5%, between 0.0001% and 2%, between 0.001% and 5%, between 0.001% and 2%, between 0.001% and 1%, between 0.001% and 0.005%, between 0.005% and 0.01%, between 0.01% and 5%, between 0.01% and 2%, between 0.01% and 1%, between 0.01% and 0.5%, between 0.01% and 0.05%, between 0.05% and 0.1%, between 0.1% and 0.5%, between 0.5% and 1%, between 1% and 2%, between 2% and 3%, between 3% and 5%, between 5% and 10%, including any range between.

In some embodiments, the surfactant has binding affinity to the polymeric core and to the CNT (e.g. SWCNT). In some embodiments, the surfactant is capable of dispersing the SWCNT in a solution (organic solution or aqueous solution). In some embodiments, the surfactant is capable of forming a stable dispersion of the SWCNTs within a solvent (e.g. organic solvent, or in an aqueous solution). In some embodiments, the surfactant predetermines the binding strength or the stability of the core-shell particle of the invention. In some embodiments, the surfactant predetermines binding strength of the shell to the core within the particle of the invention.

In some embodiments, the surfactant is characterized by a solubility in an organic solvent (e.g. polar solvent such as iso propyl alcohol, non-polar solvent such as toluene) and/or water of at least 1 g/L, at least 10 g/L, at least 50 g/L, at least 100 g/L, including any range between.

In some embodiments, the surfactant is a cationic surfactant. In some embodiments, the surfactant comprises polyalkylammonium. In some embodiments, the surfactant is or comprises polyalkylammonium-co-polyether.

In some embodiments, the surfactant is or comprises an anionic surfactant (e.g. SDBS, carboxymethyl cellulose CMC) and/or a non-ionic surfactant (e.g. polysiloxane).

In some embodiments, the surfactant forms a layer on top of the core. In some embodiments, the surfactant is devoid of polyvinyl pyrrolidone (PVP). In some embodiments, the surfactant is devoid of a co-polymer comprising PVP and/or a cellulose or a derivative thereof.

In some embodiments, the surfactant is devoid of a surfactant suitable for implementation in a dispersion polymerization (DP), also assigned as “latex polymerization”. In some embodiments, the particle of the invention is substantially devoid of the surfactant (e.g. PVP, or any other surfactant suitable for DP) adsorbed thereto. Dispersion polymerization refers to a polymerization procedure resulting in the formation of small sized (several microns) polymeric particles, characterized by spherical shape, uniform particle size and smooth outer surface. Furthermore, the polymeric particles obtained during DP are characterized by a dispersivity (are able of forming a stable dispersion, without any additional surfactant and/or dispersant) in a solution (e.g. aqueous solution).

In some embodiments, the shell comprises the CNT (e.g. SWCNT) randomly oriented or randomly distributed therewithin. In some embodiments, the shell comprises an intertwined matrix composed of randomly distributed SWCNTs and surfactant molecules. In some embodiments, surfactant molecules are bound to the CNT (e.g. SWCNT) and to the core surface. In some embodiments, the shell is in a form of a mat comprising a plurality of randomly oriented or randomly distributed SWCNTs in contact with the plurality of surfactant molecules.

In some embodiments, the shell comprises electrically conductive CNTs (e.g. electrically conductive SWCNT). In some embodiments, the melting point of the shell is substantially predetermined by the meting point or decomposition point of the CNT. In some embodiments, the thermal stability of the shell is predetermined by the decomposition point of the CNT.

In some embodiments, the shell encloses and/or is stably bound to the polymeric solid core. In some embodiments, the solid core of the particle of the invention consists essentially of a polymer. In some embodiments, at least 80%, at least 85%, at least 90%, at least 93%, at least 95%, at least 97%, at least 99%, at least 99.9%, including any range between, by weight of the core of the particle of the invention is composed of the polymer. In some embodiments, the core is substantially devoid of the CNT. In some embodiments, the core is characterized by a non-uniform surface (e.g. surface roughness of greater than 1 um, greater than 5 um, greater than 10 um, including any range between).

In some embodiments, the polymer is an organic polymer. In some embodiments, the polymer is a thermoplastic polymer. In some embodiments, the polymer in a molten state is miscible with the components of the shell (e.g. SWCNT and the surfactant). In some embodiments, the polymer in a molten state is miscible with the components of the shell (e.g. SWCNT and the surfactant), so as to result in a composite material (e.g. after solidifying of the mixture), wherein the composite is as described hereinbelow. In some embodiments, the polymer and the SWCNT and optionally the surfactant are capable of forming a homogenous composite.

In some embodiments, the thermoplastic polymer and or the core of the particle of the invention has a melting point of greater than 100° C., 110° C., 120° C., 150° C., 150° C., 200° C., 250° C., 300° C., 350° C., 400° C., 500° C., 600° C., including any range or value therebetween.

In some embodiments, the thermoplastic polymer and or the core of the particle of the invention has a melting point of between 100 and 650° ° C., between 100 and 200° C., between 200 and 400° C., between 400 and 650° C., including any range or value therebetween.

In some embodiments, the polymer comprises a thermoplastic polymer selected from polyamide (e.g. Nylon), polystyrene, polyacrylate, polyacrylate ester, polymethacrylate polyacrylamide, polyolefin, poly(bisphenol A-co-carbonate), poly(bisphenol A-co-terphtalate), polyvinyl alcohol, polyvinyl chloride and polyacrylonitrile, polyphenylene, polyether ether ketone, polyphenylene sulfide, polyetherimide, polyether sulfone, including any copolymer or any combination thereof. In some embodiments, the polymer comprises a thermoplastic resin (e.g. short-chain polymers or oligomers).

In some embodiments, the polymer comprises an acrylate-based polymer. In some embodiments, the acrylate-based polymer is selected from the group comprising polyacrylate, polyacrylate ester, polymethacrylate, polyetacrylate, polymethacrylate ester, polyethacrylate, polyethacrylate ester including any copolymer or any combination thereof.

In some embodiments, the polymer or the thermoplastic polymer comprises a polystyrene and/or a derivative thereof (e.g. a substituted polystyrene such as poly(halo-styrene), poly(alkyl-styrene), etc.).

In some embodiments, the polymer or the thermoplastic polymer comprises a polyolefin or a mixture of polyolefins. Non-limiting examples of polyolefins include but are not limited to: polyethylene (PE), LDPE, MDPE, HDPE, polypropylene (PP), polybutene, polyethylene-butene copolymer, polyethylene-propylene copolymer, atactic poly-α-olefin (APAO), amorphous poly-α-olefin (APAO), and syndiotactic polypropylene (SPP). Other polyolefins are well-known in the art.

In some embodiments, the polymer or the thermoplastic polymer comprises a polyamide or a mixture of polyamides, such as Nylon. Various nylon polymers are known in the art, such as Nylon 6, Nylon 6,6, etc.

In some embodiments, the polymer or the thermoplastic polymer composing the polymeric core is substantially devoid of electrical conductivity. In some embodiments, the polymer or the thermoplastic polymer is characterized by a volume resistivity of at least 10¹³ ohm*cm, at least 1014 ohm*cm, at least 1015 ohm*cm, including any range between.

In some embodiments, the polymer or the thermoplastic polymer composing the polymeric core is characterized by a surface resistivity of less than 1.05E+06, less than 1.05E+09, less than 1.05E+12 ohm, including any range between.

In some embodiments, the polymeric core of the invention is obtained by grinding or milling a bulk polymer, so as to obtain small polymeric particles. In some embodiments, the polymeric core comprises a rough outer surface, as described herein (e.g. due to the grinding process). Apparently, such particles are substantially non-uniformly shaped and are characterized by non-uniform particle size distribution (e.g., particles with a PDI of at least 1.5, at least 1.8, at least 2, at least 3, at least 5, at least 10, or even more, including any range between). Furthermore, the particle size of the polymeric core obtained by grinding or milling a bulk polymer is usually restricted to a particle size greater than 30 um. Smaller particle sizes require implementation of costly and tedious manufacturing processes (such as latex polymerization), and are further incompatible with common industrial extruders due to possible clogging or jamming of the extruder. Furthermore, polymeric particles with a cross-section of less than 30 um are characterized by a significantly lower feeding rate, which in turn affects the final extrusion speed.

In some embodiments, the polymeric core is or comprises a grinded particle. In some embodiments, the polymeric core is or comprises a grinded thermoplastic polymer. In some embodiments, the core is substantially devoid of a latex particle.

In some embodiments, the polymeric core of the invention further comprises a cross-linking agent, a plasticizer, or an additive (e.g. coloring agent, a binder, a stabilizer, a radical scavenger (e.g. HALS), a UV scavenger, or a combination thereof). In some embodiments, the polymeric core of the invention further comprises an additive implemented in plastic industry for the manufacturing of bulk polymers.

In some embodiments, the polymeric core of the invention is substantially devoid of a thermoset polymer. In some embodiments, the polymeric core of the invention is substantially devoid of the additive, as described herein.

In some embodiments, the polymeric core of the particle of the invention is substantially devoid of a surfactant bound thereto. In some embodiments, the polymeric core of the particle of the invention is substantially devoid of PVP, and/or a co-polymer thereof. In some embodiments, the polymeric core of the particle of the invention is substantially devoid of PVP, and/or a co-polymer thereof adsorbed to the outer surface of the polymeric core. In some embodiments, the polymeric core of the particle of the invention is substantially devoid of dispersivity (capability of forming a stable dispersion, without any additional surfactant and/or dispersant) in a solution (e.g. aqueous solution).

In some embodiments, the polymeric core of the invention consists essentially of at least one of the polymers described hereinabove.

In some embodiments, the polymeric core of the particle of the invention is characterized by a cross-section or diameter of between 30 and 2000 um, between 30 and 50 um, between 50 and 100 um, between 100 and 200 um, between 100 and 2000 um, between 200 and 300 um, between 300 and 400 um, between 400 and 500 um, between 500 and 700 um, between 700 and 1000 um, between 1000 and 1500 um, between 1500 and 1700 um, between 1700 and 2000 um, including any range between. In some embodiments, the cross-section or diameter as used herein, refers to a mean value.

In some embodiments, the particle of the invention comprises between 90 and 95%, between 80 and 95%, between 80 and 90%, between 90 and 93%, between 93 and 95%, between 95 and 97%, between 97 and 99%, by weight of the polymeric core including any range between.

In some embodiments, a w/w ratio between the core and the shell within the particle of the invention is between 10:1 and 200:1, between 10:1 and 15:1, between 15:1 and 20:1, between 20:1 and 25:1, between 25:1 and 30:1, between 30:1 and 40:1, between 40:1 and 50:1, between 50:1 and 70:1, between 70:1 and 100:1, between 100:1 and 150:1, between 150:1 and 200:1, between 200:1 and 1000:1, including any range between.

In some embodiments, a w/w ratio between the polymer and the SWCNT within the particle of the invention is between 10:1 and 100:1, between 10:1 and 15:1, between 15:1 and 20:1, between 20:1 and 25:1, between 25:1 and 30:1, between 30:1 and 40:1, between 40:1 and 50:1, between 50:1 and 100:1, between 100:1 and 1000:1, including any range between.

### Composition

In another aspect of the invention, there is a composition comprising a plurality of particles of the invention. In some embodiments, the composition of the invention is a powderous composition. In some embodiments, the composition of the invention is a solid composition. In some embodiments, the composition of the invention is in a solid state.

In some embodiments, the composition of the invention is substantially devoid of a solvent (e.g. a residual solvent, such as organic solvent, an aqueous solvent, or both).

In some embodiments, the composition comprises a plurality of distinct particles. In some embodiments, the composition is substantially devoid of particle agglomerates.

In some embodiments, the composition comprises a plurality of particles of the invention having a particle size of between 30 and 2000 um, between 30 and 35 um, between 35 and 50 um, between 50 and 100 um, between 100 and 200 um, between 100 and 2000 um, between 200 and 300 um, between 300 and 400 um, between 400 and 500 um, between 500 and 700 um, between 700 and 1000 um, between 1000 and 1500 um, between 1500 and 1700 um, between 1700 and 2000 um, including any range between. In some embodiments, the particle size as used herein, refers to a mean value.

As used herein the terms “average” or “mean” size refer to diameter of the polymeric particles. The term “diameter” is art-recognized and is used herein to refer to either of the physical diameter (also termed “dry diameter”).

In some embodiments, the dry diameter of the particles, as prepared according to some embodiments of the invention, may be evaluated using transmission electron microscopy (TEM), particle size analyzer, or scanning electron microscopy (SEM) imaging.

In some embodiments, the composition is substantially devoid of particles with a polymeric core having a cross-section or diameter of less than 50 um, less than 40 um, less than 35 um, less than 33 um, less than 31 um, less than 30 um, less than 25 um, less than 20 um, including any range between.

In some embodiments, the size of at least 90% of the particles varies within a range of greater than ±100%, ±50%, ±200%, ±300%, ±400%, ±500% including any value therebetween.

In some embodiments, a plurality of the particles have a substantially non-uniform size. In some embodiments, a plurality of the particles have a substantially non-uniform shape. In some embodiments, a plurality of the particles are polydisperse particles (e.g. characterized by a polydisperse size distribution).

The particle(s) can be generally shaped as a sphere, incomplete-sphere, particularly the size attached to the substrate, a rod, a cylinder, a ribbon, a sponge, and any other shape, or can be in a form of a cluster of any of these shapes, or can comprises a mixture of one or more shapes.

In some embodiments, a plurality of the particles have polymeric cores characterized by substantially non-uniform shape and or cross-section. In some embodiments, a plurality of the particles comprise polydisperse polymeric cores.

In some embodiments, a standard deviation of the mean cross-section of the polymeric cores is at least 50%, at least 100%, at least 200%, at least 500%, including any value therebetween.

In some embodiments, the composition of the invention further comprises additional particles, such as polymeric particles. In some embodiments, the additional particles comprise thermoplastic polymer particles. In some embodiments, the additional particles comprise a thermoplastic polymer, wherein the thermoplastic polymer is as described herein. In some embodiments, the thermoplastic polymer of the additional particle is a different polymer or is the same polymer, as the polymer of the polymeric core of the particle of the invention.

In some embodiments, the composition of the invention further comprises an additive. In some embodiments, the additive is a non-electrically conductive material. In some embodiments, the additive is or comprises a polymeric material (e.g., a thermoplastic polymer, such as described herein), a glass material, a ceramic material, or any combination thereof. In some embodiments, the additive is compatible (e.g., doesn't undergo decomposition or aggregation during the thermal processing, and/or is compatible with the thermoplastic polymer so that there is no detectable phase separation upon melting of the polymeric core) with any one of the thermal processing techniques disclosed herein, such as extrusion, thermal molding, etc.

In some embodiments, the additive is a solid. In some embodiments, the additive is in a form of a particulate matter (e.g., a fiber, a particle, a mesh, etc.). In some embodiments, the additive is or comprises polymeric particles. In some embodiments, the polymeric particles comprise (or are composed essentially of) a thermoplastic polymer. In some embodiments, the polymeric particles comprises the same polymer (e.g. having substantially the same chemical composition, and/or the same physical properties, such as melting point, glass transition point, molecular weight, etc.) as the core of the particle of the invention. In some embodiment, the additive (e.g. in a from of polymeric particles) comprises a polymer compatible with the polymer composing the core of the particle of the invention. The term “compatible” is well-known in the art, referring inter alia to the miscibility of the compounds (e.g. polymers in a molten state).

In some embodiments, the composition of the invention comprises between 1 and 99.9%, between 5 and 99.9%, between 5 and 90%, between 10 and 99.9%, between 50 and 99.9%, between 60 and 99.9%, between 70 and 99.9% of the additive by weight of the composition, including any range between, and wherein the additive is as described herein.

In some embodiments, the composition of the invention further comprises a fiber. In some embodiments, the composition of the invention further comprises a glass fiber. In some embodiments, the composition of the invention further comprises polymeric particle, as described herein.

In some embodiments, a w/w concentration of the particles of the invention within the composition (e.g. extrudable composition) is between 1 and 100%, between 1 and 10%, between 10 and 20%, between 20 and 30%, between 30 and 50%, between 50 and 70%, between 70 and 80%, between 80 and 100%, including any range therebetween.

In some embodiments, a w/w concentration of the particles of the invention within the composition is predetermines the flowability of the composition. In some embodiments, the melt flow index (MFI) of the composition of the invention is predetermined by the w/w concentration and/or chemical structure of the surfactant within the particles of the invention.

In some embodiments, the composition of the invention is compatible with an extruder. In some embodiments, the composition of the invention is extrudable. In some embodiments, the composition of the invention can be processed via an extrusion process. In some embodiments, the composition of the invention is configured for extrusion. In some embodiments, physical properties (such as particle size, chemical composition, ratio between the CNT and the thermoplastic polymer) of the composition of the invention are compatible with, or suitable for an extrusion process.

In some embodiments, an extrudable composition is characterized by MFI of between 0.1 and 100, between 0.1 and 1, between 1 and 10, between 10 and 50, between 50 and 100, including any range between.

In some embodiments, the composition of the invention is characterized by a feeding speed of between 1 and 7000 kg/hr, between 1 and 10 kg/hr, between 10 and 100 kg/hr, between 100 and 1000 kg/hr, between 1000 and 7000 kg/hr, including any range between.

In some embodiments, the particle of the invention is chemically and/or physically stable. In some embodiments, a stable composition (e.g. the composition of the invention) is substantially devoid of aggregates. In some embodiments, aggregates comprising a plurality of particles adhered or bound to each other.

In some embodiments, the particle of the invention is referred to as stable, if the particle substantially maintains its structure, and its physical properties, and/or wherein the shell of the particle remains in contact with or bound to core of the particle (e.g. substantially devoid of disintegration).

In some embodiments, the particle of the invention is referred to as chemically stable if the particle substantially maintains its chemical composition.

In some embodiments, the particle of the invention is substantially chemically and/or physically stable (e.g., the particle substantially maintains its structural and/or functional properties, such as extrudability, stability, absence of disintegration) for at least one month (m), at least 2 m, at least 6 m, at least 12 m, at least 2 years (y), at least 3y, at least 10y, including any range therebetween, wherein substantially is as described hereinbelow. In some embodiments, the particle of the invention is substantially stable for a time period described herein, at storage conditions comprising a temperature below the melting point of the thermoplastic polymer.

### Article

In another aspect of the invention, there is an article manufactured by extrusion of the composition of the invention. In some embodiments, the article is an extrudate of the composition of the invention. In some embodiments, the article is manufactured by processing of the composition of the invention. In some embodiments, processing is via a process selected from extrusion, injection, hot blown film, molding (e.g., cast molding, compression molding, rotational molding) or any combination thereof. In some embodiments, the composition of the invention is shapeable or processable so as to obtain the article of the invention.

In some embodiments, the article comprises a wall, wherein the wall is processed from the composition of the invention. In some embodiments, the wall is composed essentially of the polymeric matrix and a plurality of CNTs embedded or incorporated therewithin. In some embodiments, the plurality of CNTs or homogeneously distributed within the wall and/or within the polymeric matrix.

In some embodiments, each of the plurality of CNTs is in contact with or bound to one or more surfactant molecules. In some embodiments, the surfactant molecules substantially prevent CNT aggregation. In some embodiments, the surfactant enhances compatibility of the CNT and the polymeric matrix. In some embodiments, the surfactant enhances stability of the composition. In some embodiments, the surfactant enhances or induces dispersibility of the CNT within the polymeric matrix In some embodiments, the surfactant prevents separation of CNT and the thermoplastic polymer.

In some embodiments, the polymeric matrix comprises the thermoplastic polymer, as described hereinbelow. In some embodiments, the polymeric matrix is an intertwined matrix composed of randomly distributed polymeric chains and surfactant molecules. In some embodiments, the polymeric chains are in contact with surfactant molecules, thereby forming the matrix. In some embodiments, the polymeric chains are randomly distributed within the matrix. In some embodiments, the matrix is substantially devoid of aligned or oriented polymeric chains. In some embodiments, the matrix is substantially devoid of polymeric chains aligned or oriented in a specific direction.

In some embodiments, the wall is characterized by a thickness between 100 nm and 10 cm, between 100 nm and 1 μm, between 1 μm and 10 cm, between 10 μm and 10 cm, between 10 μm and 5 cm, between 20 μm and 10 cm, between 30 μm and 10 cm, between 40 μm and 10 cm, between 50 μm and 10 cm, between 100 μm and 10 cm, between 10 μm and 1 cm, between 1 and 10 cm, between 1 and 5 cm, between 5 and 10 cm, between 50 μm and 5 cm, between 50 μm and 1 cm, between 50 μm and 3 cm, including any range between.

In some embodiments, the wall and/or the article is characterized by a length/width dimension between 0.1 cm an 100 m, between 1 cm an 100 m, between 1 cm an 1 m, between 1 an 100 m, between 1 an 10 m, between 10 m an 100 m, including any range between.

In some embodiments, the term wall refers to a structural element of the article, wherein the shape of the wall substantially predefines the shape of the article. In some embodiments, the wall is characterized by a uniform thickness. In some embodiments, the wall is characterized by a non-uniform thickness. In some embodiments, the wall has a 2-D or a 3-D shape. In some embodiments, the wall is any of a sphere, a hemisphere, a hollow sphere, a cylinder, a hollow cylinder, a hollow hemisphere, a cone, a pyramid, a horseshoe, or any other 3-D shape. In some embodiments, the wall is substantially continuous. In some embodiments, the wall comprises one or more openings or incisions. In some embodiments, the openings are distributed in a form of a pattern on or within the wall. In some embodiments, the wall is a perforated wall. In some embodiments, the openings or perforations are distributed in a form of a pattern on or within the wall. In some embodiments, the wall is in a form of a net.

In some embodiments, the article is manufactured by a process comprising a) providing the composition of the invention under conditions suitable for extrusion, thereby obtaining an extrudate; and b) shaping the extrudate so as to obtain an article of the invention. In some embodiments, step b) is performed after performing the step a). In some embodiments, step a) further comprises drying of the extrudate under appropriate conditions, e.g. by exposing thereof to a temperature between 30 and 200° ° C. (or at least 5ºC, at least 10° C., or at least 20° C. below the melting point of the thermoplastic polymer composing the particle of the invention). In some embodiments, step b) is performed so as to obtain an article characterized by a predetermined shape.

In some embodiments, step b) is performed by a process selected from extrusion, injection, hot blown film, molding (e.g., cast molding, compression molding, rotational molding) or any combination thereof.

In some embodiments, the extrudate is in a form of a plate, a film, a particulate matter (e.g. granules), or is characterized by any three-dimensional shape, or by at least one dimension in a range between 1 mm and 100 m, including any range between. In some embodiments, the extrudate is devoid of any defined three-dimensional shape.

In some embodiments, the extrudate is shapeable via a process selected from extrusion, injection, hot blown film, molding (e.g., cast molding, compression molding, rotational molding) or any combination thereof. In some embodiments, the term “shapeable” or the term “processable” refers to the capability of the composition to obtain a predetermined shape.

In some embodiments, the article is a composite material. In some embodiments, the article of the invention is a solid composite. In some embodiments, the article of the invention is in a form of a layered composite. In some embodiments, the entire of the article or the composite material (also used herein as the “composite”) of the invention is substantially homogenous. In some embodiments, the CNT is homogenously distributed within the entire article of the invention. In some embodiments, the CNT is homogenously distributed within the polymeric matrix.

As used herein, “composite material” is a material produced from two or more constituent materials with notably dissimilar chemical or physical properties that, when merged, create a material with properties, unlike the individual elements.

In some embodiments, a composite is referred to a substantially uniform material which cannot be easily separated into individual constituents (e.g., the CNT, the surfactant, and the thermoplastic polymer of the invention). In some embodiments, a composite is substantially devoid of phase separation or disintegration (also referred to herein as “stable” composite). In some embodiments, a composite is substantially devoid of a multi-layered structure. As one of skilled in the art will appreciate, there are three types of composites (e.g., nanocomposites): unintercalated (micro composite), intercalated, or exfoliated, nanocomposites.

In some embodiments, a homogenous composite as used herein, comprises CNTs substantially uniformly distributed within the matrix. In some embodiments, a homogenous composite as used herein, comprises CNTs substantially uniformly embedded within the matrix. In some embodiments, a homogenous composite as used herein is substantially devoid of CNT aggregates (or agglomerates). In some embodiments, a homogenous composite as used herein, comprises not more than 20%, not more than 15%, not more than 10%, not more than 5%, not more than 3%, not more than 1% of aggregates including any range between, by weight relative to the total CNT content of the composite material of the invention.

In some embodiments, a homogenous composite as used herein, comprises not more than 20%, not more than 15%, not more than 10%, not more than 5%, not more than 3%, not more than 1% of aggregates including any range between, relative to the total CNT content within a cross-section of the composite material. One skilled in the art will appreciate, that the aggregation degree of the CNTs can be assessed by analyzing a micro-structure of the material, including but not limited to TEM or SEM micrographs. In some embodiments, at least 70%, at least 80%, at least 90%, at least 92%, at least 95%, at least 97%, at least 99% of the CNTs of the composite material, are organized in a plurality of distinct domains (or distinct clusters), wherein each domain is characterized by a width dimension (or cross-section) and/or length dimension of between 1 and 500 nm, between 1 and 100 nm, between 1 and 200 nm, between 1 and 10 nm, between 1 and 50 nm, between 10 and 500 nm, between 10 and 100 nm, between 50 and 500 nm, between 50 and 100 nm, between 100 and 500 nm, between 50 and 200 nm, or less than 10 μm, less than 5 μm, less than 1 μm, including any range between.

In some embodiments, a CNT aggregate is characterized by at least one dimension (e.g., thickness) of at least 1 μm, at least 5 μm, at least 10 μm, at least 50 μm, at least 100 um, at least 500 μm including any range between. In some embodiments, at least one dimension of the aggregate refers to an average value.

In some embodiments, the article is capable of and/or is configured for attenuation of an electromagnetic radiation or electromagnetic interference (EMI). In some embodiments, the wall and/or the article is shaped so as to result in EMI attenuation (e.g. EMI reflection, EMI dissipation or both).

Homogeneity of the composite material of the invention (e.g., presence of CNT aggregates) can be assessed by using an appropriate microscopic analysis of the material surface, such as by TEM, SEM etc. The analysis of micrographs (e.g., TEM and/or SEM micrographs) can be performed for example via an image processing software, which is well-known in the art. Furthermore, homogeneity can be assessed by testing the composition of the article in at least 3 different location (e.g., determining the concentration of CNT and/or surfactant). It is postulated that the standard deviation of the measured concertation values is not more than 20%, not more than 10%, not more than 5%, not more than 1%, including any range between.

Alternatively, homogeneity can be assessed by testing the EMI (Electromagnetic Interference) attenuation or shielding properties of the composition or article, as demonstrated in the Examples section.

In some embodiments, the article of the invention is shaped by providing the extrudate under conditions suitable for extrusion, injection, hot blown film, molding (e.g. cast molding, compression molding, rotational molding) or any combination thereof.

In some embodiments, the article is a solid. In some embodiments, the article comprises a polymeric matrix and a plurality of CNTs (e.g. SWCNTs) embedded or incorporated therewithin. In some embodiments, the plurality of CNTs (e.g. SWCNTs) are homogenously distributed within the matrix. In some embodiments, the polymeric matrix comprises the thermoplastic polymer, as described herein. In some embodiments, the polymeric matrix is an intertwined matrix composed of randomly distributed polymeric chains and surfactant molecules. In some embodiments, the polymeric chains are in contact with surfactant molecules, thereby forming the matrix. In some embodiments, the polymeric chains are randomly distributed within the matrix. In some embodiments, the matrix is substantially devoid of aligned or oriented polymeric chains. In some embodiments, the matrix is substantially devoid of polymeric chains aligned or oriented in a specific direction.

In some embodiments, the thermoplastic polymer of the invention forms a matrix, wherein the plurality of CNTs (e.g. SWCNTs) are in contact with or bound thereto. In some embodiments, the plurality of CNTs (e.g. SWCNTs) are physisorbed and/or chemisorbed on or within the polymeric matrix. In some embodiments, bound is via a non-covalent bond. In some embodiments, the plurality of CNTs (e.g. SWCNTs) are encapsulated by the matrix. In some embodiments, the plurality of CNTs (e.g. SWCNTs) provide reinforcement to the composite. In some embodiments, the plurality of CNTs (e.g. SWCNTs) induce or enhance electrical conductivity of the composite (or article of the invention).

In some embodiments, the article is a composite material. In some embodiments, the article of the invention is a solid composite. In some embodiments, the article of the invention is in a form of a layered composite. In some embodiments, the entire of the article or the composite material (also used herein as the “composite”) of the invention is substantially homogenous.

As used herein, “composite material” is a material produced from two or more constituent materials with notably dissimilar chemical or physical properties that, when merged, create a material with properties, unlike the individual elements.

In some embodiments, the homogenous composite is referred to a material which cannot be easily separated into individual constituents (e.g., the CNT, the surfactant and the thermoplastic polymer of the invention). As one of skilled in the art will appreciate, there are three types of nanocomposites: unintercalated (micro composite), intercalated, or exfoliated, nanocomposites.

Properties of nanocomposites are strongly dependent on the CNT concentration, surface activity and their distribution in the polymer matrix. The main challenge in development of nanocomposites or articles characterized by high electrical conductivity is uniform dispersion of CNT in the polymeric medium. One of the possible solutions, as described herein is fabrication of the core-shell particle, as described herein, thereby resulting in better homogeneity than the current industrial methods.

In some embodiments, the article or the composition of the invention consists essentially of a thermoplastic polymer, CNT, and the surfactant as described herein. In some embodiments, at least 50%, at least 60%, at least 70%, at least 80%, at least 85%, at least 90%, at least 93%, at least 95%, at least 97%, at least 99%, including any range between, by weight of the article of the invention is composed of the thermoplastic polymer. In some embodiments, at least 80%, at least 90%, at least 95%, at least 99%, at least 99.9%, of the polymeric matrix is composed of the thermoplastic polymer.

In some embodiments, CNT and/or the surfactant (and optionally any additional component of the composition) are miscible or compatible with the thermoplastic polymer in a molten state. In some embodiments, the thermoplastic polymer in a molten state is miscible or compatible with the additional components of the composition, so as to form a composite material (e.g., upon cooling thereof below the glass transition temperature of the thermoplastic polymer). In some embodiments, the thermoplastic polymer in a molten state is compatible with the CNT, such that the resulting mixture is substantially devoid of phase separation and/or aggregation.

In some embodiments, the thermoplastic polymer in a molten state is miscible with additional components of the composition, so as to result in a homogenous composite material (e.g., after solidifying of the mixture). In some embodiments, the thermoplastic polymer, and the CNT and optionally the surfactant are capable of forming a homogenous composite.

In some embodiments, the article of the invention comprises the CNT (e.g. SWCNT) and the surfactant embedded within the polymeric matrix, wherein a w/w concentration of the surfactant and/or of the CNT within the article is between 0.01% and 5%, between 0.01% and 0.05%, between 0.05% and 0.1%, between 0.1% and 0.5%, between 0.5% and 1%, between 1% and 2%, between 2% and 3%, between 3% and 5%, between 5% and 10%, including any range therebetween.

In some embodiments, the article of the invention comprises the CNT (e.g. SWCNT) and the surfactant embedded within the polymeric matrix, wherein a w/w concentration of the surfactant and/or of the CNT within the article is between 0.00001% and 5%, 0.00001% and 0.01%, between 0.00005% and 5%, between 0.00001% and 0.00005%, between 0.00001% and 0.0001%, between 0.00001% and 0.001%, between 0.0001% and 5%, between 0.0001% and 2%, between 0.001% and 5%, between 0.001% and 2%, between 0.001% and 1%, between 0.001% and 0.005%, between 0.005% and 0.01%, between 0.01% and 5%, between 0.01% and 2%, between 0.01% and 1%, between 0.01% and 0.5%, between 0.01% and 0.05%, between 0.05% and 0.1%, between 0.1% and 0.5%, between 0.5% and 1%, between 1% and 2%, between 2% and 3%, between 3% and 5%, between 5% and 10%, including any range therebetween.

In some embodiments, the content of the non-SWCNT carbon nanostructures (e.g., MWCNT, etc.) within the article and/or the composition described herein, is at most 30%, at most 25%, at most 20%, at most 15%, at most 10%, at most 5%, at most 1% including any range between, by weight relative to the total CNT content of the article.

In some embodiments, the total CNT content is referred to herein, as a weight portion of the SWCNT and optionally at least one an additional carbon nanostructure (such as MWCNT, carbon black, fullerene, graphene, etc.) within the article of the invention.

In some embodiments, the composition is substantially devoid of an additional carbon nano-particle. In some embodiments, the composition is substantially devoid of an inorganic material (e.g., metal, glass, mineral including any particles, or any fibers thereof). In some embodiments, the composition is substantially devoid of a fiber (e.g., carbon fiber etc.). In some embodiments, the terms carbon nanostructure and carbon nano-particle are used herein interchangeably.

In some embodiments, the electrical conductivity of the article (or composite) is greater than the electrical conductivity of the pristine polymer (e.g. devoid of CNT and/or surfactant) by at least 50%, at least 100%, at least 200%, at least 500%, at least 1000%, at least 10000%, at least 1000000000% including any range therebetween.

In some embodiments, the electrical conductivity of the article is by at least 10, at least 100, at least 1000, at least 10000, at least 100.000 times, at least 1.000.000 times, at least 10.000.000 times greater than the electrical conductivity of the pristine polymer, including any range therebetween.

In some embodiments, the article of the invention is characterized by volume resistivity of between 10¹² and 1 ohm*cm, between 10¹² and 10¹⁰ ohm*cm, between 10¹⁰ and 10⁸ ohm*cm, between 10⁸ and 10⁶ ohm*cm, between 10⁶ and 10⁴ ohm*cm, between 10⁴ and 10² ohm*cm, between 10² and 1 ohm*cm, including any range therebetween.

In some embodiments, the article of the invention is physically stable. In some embodiments, a stable article is substantially devoid of phase separation (e.g. disintegration of the composite accompanied by separation between CNT and the polymeric matrix). In some embodiments, a stable article is substantially devoid of cracking, deformation or other physical defects. In some embodiments, a stable article substantially retains its shape, dimensions and/or physical properties, such as mechanical strength, electrical conductivity, etc.

According to another aspect of the present invention there is provided a coated substrate, comprising a substrate in contact with the article of the invention in the form of a coating.

In some embodiments, the coating comprises the composite (e.g. the solid composite) disclosed herein. In some embodiments, the coating is in a form of a film. In some embodiments, the film forms a substantially uniform layer. In some embodiments, the coating is in a form of a solid. In some embodiments, the coating is substantially devoid of a solvent (e.g., any residual solvent from the manufacturing process). In some embodiments, a w/w concentration of a residual solvent within the coating is less than 5%, less than 3%, less than 2%, less than 1%, less than 0.5%, less than 0.1% including any range between.

In some embodiments a coating layer as described in any of the respective embodiments is incorporated in and/or on at least a portion of the substrate. In some embodiments a coating layer as described in any of the respective embodiments is incorporated in and/or on at least a portion of at least one surface of the substrate. In some embodiments, the term “coating layer” and the term “coating” are used herein interchangeably.

Without being bound by any particular theory or mechanism, it is assumed that the polymer provides an adhesiveness property to the substrate, and the CNT (e.g. SWCNT) provide additional physical properties to the final coating (e.g., electrical conductivity, mechanical strength, etc.).

In some embodiments, the coating layer represents a surface coverage referred to as “layer” e.g., 100%. In some embodiments, the coating layer represents about 90%, about 80%, about 70%, about 60%, about 50%, about 40%, of surface coverage, including any value therebetween. In some embodiments, the substrate further comprises a plurality of coating layers.

In some embodiments, the coating layer is homogeneously deposited on a surface. In some embodiments, the coating is substantially devoid of cracks, scratches and/or other structural defects.

In some embodiments, the coating is bound or adhered to the substrate. In some embodiments, the coating is embedded on or within the substrate. In some embodiments, the coating is physiosorbed to the substrate. In some embodiments, the coating is stably bound to the substrate.

In some embodiments, the coating is in contact with at least 10%, at least 20%, at least 30%, at least 40%, at least 50%, at least 70%, at least 90%, at least 95%, at least 99%, at least 99.9% of the substrate surface. According to an embodiment of some embodiments of the present invention, there is provided a substrate having incorporated in and/or on at least a portion thereof the disclosed coating layer as described herein.

In some embodiments, the article is substantially stable (e.g., the article substantially maintains its structural and/or functional properties, such as physical stability, and/or absence of disintegration or erosion of the coating layer) for at least one month (m), at least 2 m, at least 6 m, at least 12 m, at least 2 years (y), at least 3y, at least 10y, including any range therebetween, wherein substantially is as described hereinbelow.

In some embodiments, the article is substantially stable upon exposure to a thermal radiation. In some embodiments, the thermal radiation comprises a temperature of between 30 and 100° ° C., between −50 and 0° ° C., between 0 and 10° C., between 10 and 30° C., between 30 and 50° ° C., between 50 and 70° ° C., between 70 and 100° ° C., between 100 and 150° C., including any range therebetween. In some embodiments, the thermal radiation comprises a temperature lower than the melting point of the thermoplastic polymer.

As used herein the term “stable” refers to the ability of the article to substantially maintain its structural, physical and/or chemical properties. In some embodiments, the article is referred to as stable, when it substantially maintains its structure (e.g. shape, and/or a dimension such as thickness, length, etc.), wherein substantially is as described herein.

In some embodiments, the coating layer is referred to as stable, when it is substantially devoid of cracks, deformations or any other surface irregularities.

In some embodiments, the terms “coating” and “coating layer” are used herein interchangeably.

Substrate usable according to some embodiments of the present invention can have, for example, organic or inorganic surfaces, including, but not limited to, glass surfaces; porcelain surfaces; ceramic surfaces; silicon or organosilicon surfaces, metallic surfaces (e.g., stainless steel); polymeric surfaces such as, for example, plastic surfaces, rubbery surfaces, paper; wood; fabric in a woven, knitted or non-woven form; mineral (rock or glass), surfaces, wool, silk, cotton, hemp, leather, plastic surfaces and surfaces comprising or made of polymers, nylons, inorganic polymers such as silicon rubber or glass; or can comprise or be made of any of the foregoing substances, or any mixture thereof. substrates are selected from but are not limited to polymers of polycarbonate, polyesters, nylons, and metallic foils such as aluminum foil, with nylons and metallic foils.

In some embodiments, the substrate is in a form of a continuous layer or a woven or a non-woven substrate.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

The term “enhancing” is by at least 10%, at least 20%, at least 30%, at least 40%, at least 50%, at least 60%, at least 80%, at least 100%, at least 150%, at least 200%, at least 250%, at least 300%, including any range or value therebetween.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “substantially” refers at least 60%, at least 70%, at least 80%, at least 85%, at least 90%, at least 95%, at least 97%, at least 99%, at least 99.9%, including any rage or value therebetween. In some embodiments, the terms “substantially” and the term “consisting essentially of” are used herein interchangeably.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples. Reference is now made to the following examples, which together with the above descriptions illustrate some embodiments of the invention in a non-limiting fashion.

### EXAMPLES

### Example 1

### Preparation of Nylon 6 Based Core-Shell Particles

Polymeric particles: Polyamide (PA) Nylon 6 powder, particle size 30-1300 μm (purchased from LANXESS, DOMO, BASF etc.)

SWCNT: outer mean diameter 1.6 nm, length>5 μm.

Surfactant: Polyether copolymer based surfactant.

The Nylon 6 powder was coated, so as to obtain exemplary core-shell particles of the invention, wherein a w/w ratio between the core and the shell is about 100:1.

The core-shell particles of the invention (in a form of dry powder) were extruded by Twin screw extruder, Coperion, ZSK 18MegaLab, D=18 mm, 48 L/D.

Following compositions have been exemplified and tested:

| | % w/w of [neat polyamide particles + | |
|---|---|---|
| sample | mineral fibers (10-13 μm diameter, | % w/w of particles |
| # | 3-4.5 mm in length)] | of the invention |
| 4 | 90 | 10 |
| 5 | 80 | 20 |
| 6 | 70 | 30 |
| 7 | 100 | 0 |

Exemplary powderous compositions have been injected by Injection molding machine, BOY 22A, 22-ton, D=24 mm, 22 L/D into a ISO 294, Injection molding of test specimens of thermoplastic materials.

Volume resistivity of 1-2 mm thick specimen from each of the tested materials has been examined by a standard resistivity test (IEC62631-3-1/2) with 2 or 4 electrodes.

Volume resistivities of the tested materials are summarized below:

| | % w/w of [neat polyamide | | |
|---|---|---|---|
| | particles + mineral fibers | % w/w of | |
| | (10-13 μm diameter, 3- | particles of | volume |
| sample # | 4.5 mm in length)] | the invention | resistivity |
| 4 | 90 | 10 | 1.32E+09 |
| 5 | 80 | 20 | 6.87E+06 |
| 6 | 70 | 30 | 1.60E+06 |
| 7 | 100 | 0 | 1.10E+12 |

Polycarbonate and polyethylene powder has been successfully implemented in the above described coating process, resulting in a conductive article.

Additional surfactants such as Polyester-based block copolymer, and polyacrylic acid-co-maleic acid have been successfully implemented for the manufacturing of core-shell polymeric particles of the invention. Subsequently, exemplary conductive articles have been formed by extrusion of the core-shell particles. The tested articles exhibited enhanced conductivity (volume resistivity of between 10¹² and 10⁶).

Furthermore, the coating has been also performed in an aqueous SWCNT dispersion using SDBS, CMC as the surfactant. Subsequently, exemplary conductive articles have been formed by extrusion of the core-shell particles. The tested articles exhibited enhanced conductivity (volume resistivity of between 10¹² and 10⁶).

### Example 2

### Coating of Nylon 6 Based Millimeter-Sized Core-Shell Particles

Polymeric particles: Polyamide (PA) Nylon 6 pellets, particle size ˜ 2-3 mm. (purchased from LANXESS, DOMO, BASF etc.)
SWCNT: outer mean diameter 1.6 nm, length>5 μm
Surfactant: Polyether copolymer based surfactant

The coating has been performed according to the conditions described in the Example 1.

Subsequently, shell adhesion was tested by extracting the resulting particles with IPA. Surprisingly, the inventors observed that the resulting particles were unstable (i.e. the particles undergo disintegration by contacting with a polar solvent), and that the shell was easily separated from the polymeric core by solvent extraction with IPA. Accordingly, by implementing polymeric particles with a particle size greater than 2 mm, the obtained core-shell particles easily undergo disintegration. Apparently, the resulting particles are not extrudable, since the SWCNT-based shell disintegrates during the feed stage.

### Example 3

An exemplary article of the invention comprising a wall composed of the composition of the invention, has been fabricated by extrusion and/or molding of core-shell particles described herein and comprising very low amount of CNT (see Table 1).

Polyamide (Polyamide 6) and SWCNT based core-shell particles have been implemented for the manufacturing of an exemplary article in a form of a plaque. The composition of the core-shell particles was as follows: Polyamide (PA 6) powder, particle size 30-1300 μm (purchased from LANXESS, DOMO, BASF, etc.); SWCNT 1 wt % (outer mean diameter 1.6 nm, length>5 μm, purchased from OCSiAl); Surfactant: Polyether copolymer based surfactant.

The core-shell particles have been manufactured as follows: Nylon 6 particles were coated with SWCNTs to obtain the Nylon6/CNT core-shell particles wherein a w/w ratio between the core and the shell is about 100:1-10:1. The chemical compositions of the exemplary core-shell particles are identical with the compositions of articles presented in Table 1 below.

In an exemplary embodiment, an article of the invention has been manufactured via extrusion of exemplary core-shell particles in a twin screw extruder, (Coperion, ZSK 18MegaLab, D=18 mm, 48 L/D) under appropriate conditions.

The extrudate has been subsequently dried at about 40-100° C. for about 0.5-10 h.

The dried extrudate has been further shaped (e.g., by compression molding) to obtain 10 cm*10 cm plaques (thickness of about 300 μm). EMI attenuation of the exemplary articles processed from the core-shell particles described herein, has been tested as described hereinbelow and compared to the EMI attenuation of (i) pristine polymer devoid of CNT, and (ii) a control article having the same composition which has not been processed from the core-shell particles of the invention (denoted as P9-158-1). FIG. 1C is a micrograph demonstrating a non-homogenously dispersion of CNT within the polymeric matrix of the control article.

P9-158-1 has been prepared by molding (e.g., by compression molding) of a mixture composed of polyamide 6 and 0.2% CNT by weight, to obtain a non-homogeneous 10 cm*10 cm plaques (thickness of about 300 μm).

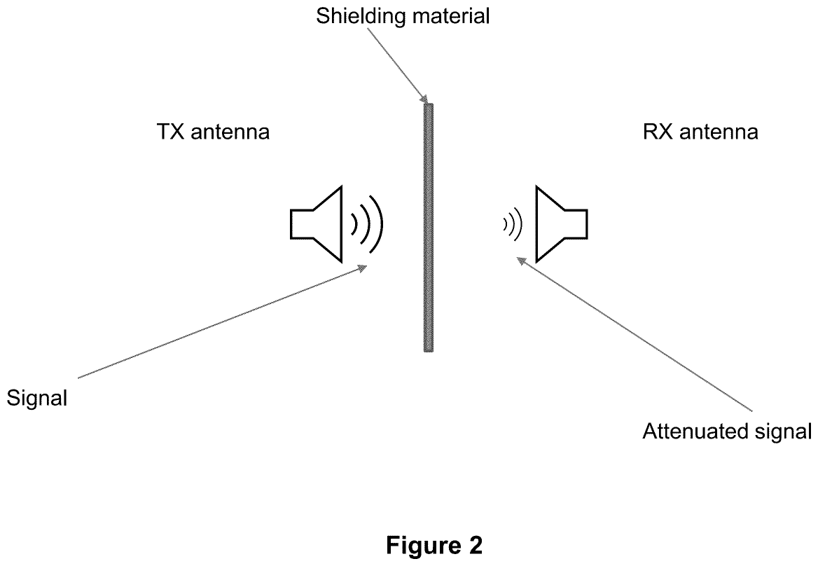

The measurements were performed in the labs of the Schlesinger Center for Radiation Sources and Applications at Ariel University, Israel. In brief, a transmission antenna and a receiving antenna connected to the network analyzer are aligned to each other (as presented by FIG. 2). Calibration measurements S21 take place without a test plate (free field).

For the measurement, the test plate is introduced into the center of the radiation field perpendicular to the antennas, such that the center of the test plate is positioned on an imaginary straight line between the transmission antenna and the receiving antenna.

The specimen is aligned level with and perpendicular to the electromagnetic wave's direction of transmission. The transmission properties are obtained by measuring the S21 parameters on the network analyzer.

The results of this experiment are presented in FIG. 1A. The values in FIG. 1A are referred to EMI attenuation relative to the attenuation of the pristine polymer. As shown in FIG. 1A, within the entire tested wavelength range an exemplary article of the invention exhibited EMI attenuation being between 2-5 orders of magnitude greater than the EMI attenuation of the non-homogenous control.

Table 1 below presents exemplary compositions of the articles of the invention, showing high EMI shielding even at low CNT concentrations of between 0.005-1 wt %.

TABLE 1
compositions and EMI attenuation (between 75 and 110 GHz) of
exemplary articles of the invention

| | | | | | PA6*(P9- |
|---|---|---|---|---|---|
| Polymer | PA6* | PA6 | PA6 | PA6* | 158-1) |
| Length (cm) | 10 | 10 | 10 | 13 | 10 |
| Width (cm) | 10 | 10 | 10 | 7.5 | 10 |
| Thickness (cm) | 0.03 | 0.03 | 0.05 | 0.2 | 0.03 |
| Density (g/cm3) | 1.4 | 1.11 | 1.10 | 1.55 | 1.85 |
| Weight PA6 (g) | 3.24 | 3.24 | 5.4 | 22.23 | 5.55 |
| % wt. CNT | 0.20% | 1% | 0.10% | 0.05% | 0.2%** |
| Attenuation (dB) | 32 | 35 | 30.76 | 18.98 | 7.6 |

*the sample further comprises glass fibers;
**CNT distribution is not homogenous

The pristine polymer with substantially the same dimensions as the tested specimens, showed a negligible attenuation (about 0-5 dB).

Moreover, as presented in FIGS. 1B-1C, an exemplary article processed from the core-shell particles of the invention has been characterized by substantially homogenous distribution of CNTs within the polymeric matrix, as depicted in FIG. 1B showing a substantially uniform distribution of CNTs without any detectable agglomerates. In contrast, P9-158-1 has been characterized by non-homogenous distribution of CNTs (and even phase separation), with the CNT aggregates visually detectable on the article's surface (see FIG. 1C).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A particle comprising a polymeric core in contact with a shell comprising CNT, wherein: said polymeric core comprises a thermoplastic polymer; and a size of said particle is between 1 and 2000 μm.

2. The particle of claim 1, wherein a weight portion of said CNT within said particle is between 0.00001 and 5%.

3. The particle of claim 1, wherein said polymer has a volume resistivity of at least 10¹³ ohm*cm; and wherein said CNT is a single-wall CNT (SWCNT).

4. The particle of claim 1, wherein said shell comprises a surfactant.

5. The particle of claim 4, wherein said surfactant is a cationic surfactant.

6. The particle of claim 5, wherein said cationic surfactant comprises polyalkylammonium-co-polyether.

7. The particle of claim 4, wherein a w/w ratio of said surfactant to said CNT is between 10:1 and 0.5:1.

8. The particle of claim 1, wherein said thermoplastic polymer is characterized by a melting temperature at least 100° C.

9. A composition comprising a plurality of particles of claim 1.

10. The composition of claim 9, further comprising an additive, wherein a w/w ratio between the additive and the plurality of particles within the composition is between 1:100 and 100:1.

11. The composition of claim 10, wherein said additive comprises glass fiber, polymeric particles, or both.

12. The composition of claim 9, wherein said composition is characterized by a Melt Flow Index (MFI) between 0.1 and 100.

13. The composition of claim 9, wherein said composition is extrudable, and wherein a weight portion of (i) the CNT, or (ii) of the surfactant within said composition is independently between 0.01 and 5%.

14. An article comprising a thermoplastic polymer, a surfactant and a plurality of CNTs homogenously distributed within said article, wherein a weight portion of (i) the CNT, or (ii) of the surfactant within said article is independently between 0.01 and 5%.

15. The article of claim 14, wherein said article is manufactured by processing the composition a plurality of particles comprising a polymeric core in contact with a shell comprising CNT, wherein: said polymeric core comprises a thermoplastic polymer; and a size of said particle is between 1 and 2000 μm.

16. The article of claim 14, wherein said article is characterized by volume resistivity of between 10¹² and 1 ohm*cm.

17. The article of claim 14, wherein each of (i) CNT and (ii) surfactant is independently present within said article at a w/w concentration of between 0.01% and 5%; and wherein said article is characterized by volume resistivity of between 10¹⁰ and 10² ohm*cm.

18. The article of claim 14, wherein said CNT is a SWCNT; the surfactant is a cationic surfactant, optionally comprising polyalkylammonium-co-polyether; and wherein said thermoplastic polymer is characterized by a melting temperature of at least 100° ° C.

19. The article of claim 14, wherein a w/w ratio of said surfactant to said CNT is between 10:1 and 0.5:1.

20. The article of claim 15, wherein said processing is by any of: extrusion, injection, hot blown film, and molding or any combination thereof.

21.-22. (canceled)
